(19) United States
(12) Patent Application Publication
(10) Pub. No.: US 2010/0131329 A1
(43) Pub. Date: May 27, 2010

(54) METHOD AND SYSTEM FOR SMART METER PROGRAM DEPLOYMENT

(75) Inventors: Lianjun An, Yorktown Heights, NY (US); Jayant R. Kalagnanam, Tarrytown, NY (US); Sashidhar Pemmasani, Atlanta, GA (US); Dharmashankar Subramanian, Tarrytown, NY (US); Mark A. Welch, Coppell, TX (US)

Correspondence Address: SCULLY, SCOTT, MURPHY & PRESSER, P.C., 400 GARDEN CITY PLAZA, SUITE 300, GARDEN CITY, NY, 11530, US

(73) Assignee: INTERNATIONAL BUSINESS MACHINES CORPORATION, Armonk, NY (US)

(21) Appl. No.: 12/277,542

(22) Filed: Nov. 25, 2008

(51) Int. Cl. G06Q 10/00

(52) U.S. Cl. 705/10

(57) ABSTRACT

A method, system and article of manufacture are disclosed for modeling a plan for deployment of smart meters in a plurality of locations that are attached to a grid operated by an energy provider that supplies energy to said locations, wherein the smart meters are used to measure the energy supplied by the energy provider to said locations. The method comprises the steps of using a market diffusion model to create a time-varying user adoption profile, including estimating the time lagged benefits realized from deployment of the smart meters; and estimating a response in the demand for said energy due to adoption of the smart meters. A program is used to capture the time-lagged benefits and a given set of constrains for a chosen planning time horizon to develop a meter deployment plan across the various locations and over that planning horizon.

### BACKGROUND OF THE INVENTION

1. Field of the Invention

The present invention generally relates to the transition to smart utility or energy meters, and more specifically, to a method and system for modeling a plan for deploying smart meters.

2. Background Art

Energy Delivery Companies are planning to deploy smart meters for their residential and commercial customers. Such an Advanced Metering Infrastructure (AMI) would enable two-way communication. Specifically, AMI includes a communication information system and distribution automation system. Companies can use the system to monitor and collect the hourly or sub-hourly electricity usage from each customer and to diagnose occurring problems (trouble shooting). More important, companies can use the system to pose the whole network load and pricing information to customer in real time and expect that price-sensitive customers change their usage pattern (referred to as Demand Response) to reduce the peak demand and to increase non-peak demand. These features provide the customer feedback mechanisms that encourage economic investment and rational market behavior. This Demand Response is known to have several documented benefits for the consumer, utility companies, as well as society. See, for example, Baer, W. S., B. Fulton, S. Mahnovski, “Estimating the Benefits of the GridWise Initiative Phase I Report”, TR-160-PNNL, Rand Science and Technology, May 2004. (Baer, et al.). Further, upon proliferation of Plug-in Hybrid Automobiles in society, and the enablement of sell-back of energy from a Plug-in Hybrid Battery to the grid, via AMI, price-sensitive customers that own Plug-in Hybrids have an economic incentive to charge up their batteries in non-peak periods and sell-back excess energy to the grid during peak-periods. This phenomenon can potentially lead to further reduction in the peak-demand witnessed by Utility companies from an energy production perspective. The demand response related benefits of AMI may be adjusted to account for this phenomenon to make the assessment of the AMI business case, if so desired.

Since the technology is new, and the customer uptake and adoption rate is unknown, there is a need for modeling the business case of Smart Meter deployment, in order to develop optimal program deployment plans. Such a model needs to address time-lags in the benefit realization profile, for both:

Demand Response related benefits due to lag in User Adoption & Information Systems Maturity, as well as Additional Demand Response Benefits adjusted for the lag in Plug-in Hybrid diffusion and sell-back adoption; and

Non-Demand Response related benefits (such as Reduction in Manual Force) due to lag in Information Systems Maturity.

Further, it also needs to address budget availability constraints, workforce acquisition and availability constraints, smart meter procurement and lead-time constraints, for developing an optimal program deployment plan, which en codes the technology diffusion/maturity related delays in benefit realization. It also needs to estimate the price-sensitive Demand Response benefits by incorporating hourly annual load profiles, customer demand-price elasticity, and the time-of-use nature of real-time prices.

Lastly, since the horizon of the business case for Smart Meter deployment extends into several years into the future, the model needs to address the uncertainties associated with the forecasted costs and benefits, stemming from uncertainties in various parameters that play into the model.

The model also needs to distinguish between Residential, Commercial and Industrial customer classes, since the costs and benefits vary among these different types of customers.

The model also needs to allow for replanning at various points in time, into the Deployment Implementation, to adjust for scheduling delays and other uncertainties.

As mentioned in A. Faruqui and S. George, “Quantifying Customer Response to Dynamic Pricing”, The Electricity Journal, Vol. 18 (4), pp. 1040-6190, (Faruqui, et al.), business cases in support of system-wide AMI implementation have not proven successful, since, to date, the scope of issues related to cost-justification of AMI is too narrow and that known implementation methodologies mainly focus on minimizing cost. It is a great challenge to predict the profitability from such investment in AMI. Energy delivery companies face future uncertainty from market demand and resource availability during implementation of the new infrastructure. Some of the benefits, such as economic benefits from demand response (with and without Plug-in Hybrids and Energy Sell-Back under consideration), depend on customer adoption rate of AMI technology and time-lagged economic effects, which are difficult to estimate due to the dependency on intangible measures, such as marketing effectiveness, word-of-mouth, etc.

### SUMMARY OF THE INVENTION

An object of this invention is to provide a framework to manage the time-phased deployment planning of an Advanced Metering Infrastructure.

Another object of the present invention is to address the management issues that are pertinent to implementing an Advanced Metering Infrastructure program from a business case development and planning perspective.

A further object of the invention is to provide an integrated model for Advanced Metering Infrastructure program management that takes advantage of both system dynamics and linear programming methodologies.

Another object of this invention is to use system dynamics to estimate intangible measures in the management of an Advanced Metering Infrastructure deploying program.

These and other objectives are attained with a method, system and article of manufacture for modeling a plan for deployment of smart meters in a plurality of locations that are attached to a grid operated by an energy provider that supplies energy to said locations, wherein the smart meters are used to measure the energy supplied by the energy provider to said locations. The method comprises the steps of using a market diffusion model to create a time-varying user adoption profile, including estimating the time lagged benefits realized from deployment of the smart meters; and estimating a response in the demand for said energy due to adoption of the smart meters, with and without Plug-in Hybrid Automobiles and Energy Sell-Back under consideration. A program is used to capture the time-lagged benefits and a given set of constrains for a chosen planning time horizon to develop a meter deployment plan across the various locations and over the chosen planning horizon.

In a preferred embodiment the method comprises the further step of re-planning to account for changes of resource and budget, and to enable a parameter estimation functionality to iteratively calibrate the market diffusion model. In addition, preferably the step of using a market diffusion model includes the step of capturing the time-lagged benefit realization profiles for both demand response and non-demand response related benefits, with and without Plug-in Hybrids and Energy Sell-Back under consideration; and this step of capturing the time-lagged benefit realization profile, in turn, includes the step of using a system dynamic model that includes technology diffusion related delays and system maturity related delays, with and without Plug-in Hybrids and Energy Sell-Back under consideration.

The preferred embodiment of the invention addresses the management issues that are pertinent to implementing an AMI program from a business case development and deployment planning perspective, and provides an integrated end-to-end approach. This embodiment of the invention uses a market diffusion model based on System Dynamics to create a time-varying user adoption profile. It includes marketing effectiveness and word-of-month effect on customer behavior. The model is also used to estimate the lag in benefits realization from the new technology deployment, arising from the above dynamics of user adoption, coupled with a lag in the maturity of the supporting Information Systems that enable effective functioning of the new technology. This preferred embodiment of the invention needs estimates of demand response driven economic benefits that are obtainable from effective adoption of the new technology. An econometric model is used to estimate the price-sensitive response of user demand, which is facilitated by the new technology. The preferred embodiment enables the above considerations, both with and without Plug-in Hybrids and Energy Sell-Back under consideration. In the case of considering Plug-in Hybrids and Energy Sell-back via AMI, the System Dynamics model also captures the market diffusion and proliferation of Plug-in Hybrids among consumers. The Demand Response model is further nuanced, in this case, to account for both: Increased demand during non-peak periods resulting from price-sensitive owners of Plug-in Hybrids for charging the batteries, and an Additional Decrease in the Peak-Demand witnessed by the Utility (for Energy Production) due to Energy Sell-back from charged-up batteries in the Plug-in Hybrids, back to the grid.

A mathematical programming model is used to capture the above time-lagged benefits and costs as well as operational constraints for a chosen planning horizon, which is typically order of 15-20 years. By maximizing profit through the model, the present invention may be used to achieve an optimized meter deployment plan, across various jurisdictions and over the chosen planning horizon. A re-planning step is, preferably, introduced during the plan implementation process. There are two reasons for introducing this step. One is related to the change of resource and/or budget, which may force re-planning. The other reason is to enable a parameter estimation functionality, which can be invoked to close mismatch between the mathematical model and reality, in a manner similar to model predictive control in control theory. It allows periodic updating of parameter settings for the market diffusion model as well as the demand response model based on observed data so far. The re-planning would close the loop and iteratively calibrate the market diffusion and demand response models.

In the preferred embodiment of the invention described herein in detail, the term adoption percentage is the percentage (or fraction) of the number of users with installed smart meters that are adopting Demand Response. Also, this preferred embodiment may be considered as being comprised of several steps. In Step (1), the Systems Dynamics model addresses the user adoption percentage by estimating the adoption percentage dynamics using a logistic innovation diffusion model. The logistical innovation diffusion model has two main benchmarks: marketing effectiveness per unit time and adoption from word of mouth per unit time. In initial stages of deployment, the growth rate of adoption percentage is driven by smart meter users that have learned about Demand Response from marketing (according to the model). As the adoption percentage grows, and the pool of potential adopters declines, growth rate of adoption percentage is increasingly driven by word of mouth, and the effect of marketing declines. Word of mouth is an interaction between the Adopters & the Pool of Potential Adopters. In the case of considering Plug-in Hybrids and Energy Sell-back via AMI, the System Dynamics model also captures the market diffusion and proliferation of Plug-in Hybrids among consumers.

The Systems Dynamics model also addresses the Demand Response benefits realization delays due to two types of delays. 1) system delay due to the time-to-maturity of the Information Systems, and 2) adoption delay due to the dynamics of adoption percentage, or Customer Uptake. Growth rate of adoption percentage, which tracks the number of users with smart meters expected to adopt Demand Response, leads to a time-lag between the installation of smart meters and the adoption of Demand Response by the users of these smart meters. Moreover, the systems dynamics model for estimating the system delay in the maturity of information systems is a first order delay process. The adoption delay is the same as is used in the adoption percentage systems dynamic model, where net delay in Demand Response benefit realization is a product of the above two delays. Similarly, the Systems Dynamics model also estimates delay in Non-Demand Response related benefits.

In Step (2), the estimation of Demand Response benefits is carried out by processing the data input using a mathematical model that uses hourly annual load profiles, hourly clearing prices for each day, customer demand-price elasticity, time-of-use nature of real-time prices, and fixed commodity price thresholds for residential, commercial, and industrial customer classes, resulting in an estimation output. The Demand Response model is further nuanced, in the case of consideration of Plug-in Hybrids and Energy Sell-back via AMI, to account for both: Increased demand during non-peak periods resulting from price-sensitive owners of Plug-in Hybrids for charging the batteries, and an Additional Decrease in the Peak-Demand witnessed by the Utility (for Energy Production) due to Energy Sell-back from charged-up batteries in the Plug-in Hybrids, back to the grid.

In Step (3), a program deployment model is set up for receiving and processing data inputs in accord with the disclosed mathematical program to produce an output that identifies and highlights the net benefits, i.e., total benefits adjusted for total costs that are accumulated over a desired implementation including Demand Response benefits estimated in Step 2 while encoding the benefit realization delays from Step 1. In more detail Step (3) does so by developing a smart meter deployment plan that achieves the above objectives in view of hard budget constraints in model time periods, meter availability constraints with procurement lead-time, lower bounds on desired net benefits in each model time period, workforce acquisition/training costs, actual lead-times, and other constraints.

### BRIEF DESCRIPTION OF THE DRAWINGS

FIG. 1 shows the information flows among the various modeling components used in a preferred embodiment of the invention;

FIG. 2 illustrates program drivers that may provide inputs for the modeling components;

FIG. 3 shows a System Dynamics model that may be used in the present invention;

FIGS. 4A and 4B are diagrams depicting adoption percentage and benefit realization that may be achieved with this invention;

FIG. 5 depicts an electricity demand profile for a typical day;

FIGS. 6A and 6B are graphs that together show the cost and benefit as well as the corresponding meter procurement for a time horizon of 21 years;

FIGS. 7A and 7B are graphs that together show a corresponding workforce profile formed in accordance with a preferred embodiment of the invention;

FIG. 8 shows an accumulative percentage deployment plan in different jurisdictions;

FIGS. 9A and 9B are graphs that show the cost, benefit and deploy plan under a given budget limit;

FIGS. 10A and 10B are graphs that together show the cost, benefit and procurement profile under given budget and supply constraints; and

FIG. 11 shows a computer system, which may be used to implement the present invention.

### DETAILED DESCRIPTION OF THE INVENTION

The preferred embodiment of the present invention may be considered as being comprised of several steps. In Step (1) a Systems Dynamics model addresses the user adoption percentage by estimating the adoption percentage dynamics using a logistic innovation diffusion model. The logistical innovation diffusion model has two main benchmarks: marketing effectiveness per unit time and adoption from word of mouth per unit time. In initial stages of deployment, the growth rate of adoption percentage is driven by smart meter users that have learned about Demand Response from marketing (according to the model). As the adoption percentage grows, and the pool of potential adopters declines the growth rate of the adoption percentage is increasingly driven by word of mouth, and the effect of marketing declines. Word of mouth is an interaction between the Adopters & the Pool of Potential Adopters.

The Systems Dynamics model also addresses the Demand Response benefits realization delays due to two types of delays: 1) system delay due to the time-to-maturity of the Information Systems, and 2) adoption delay due to the dynamics of adoption percentage, or Customer Uptake. Growth rate of adoption percentage, which tracks the number of users with smart meters expected to adopt Demand Response, leads to a time-lag between the installation of smart meters and the adoption of Demand Response by the users of these smart meters. Moreover, the systems dynamics model for estimating the system delay in the maturity of information systems is a first order delay process. The adoption delay is the same as is used in the adoption percentage systems dynamic model, where net delay in Demand Response benefit realization is a product of the above two delays. Similarly, the Systems Dynamics model also estimates delay in Non-Demand Response related benefits.

In Step (2), the estimation of Demand Response benefits is carried out by processing the data input using a mathematical model that uses hourly annual load profiles, hourly clearing prices for each day, customer demand-price elasticity, time-of-use nature of real-time prices, and fixed commodity price thresholds for residential, commercial, and industrial customer classes, resulting in an estimation output.

In Step (3), a program deployment model is set up for receiving and processing data inputs in accord with the disclosed mathematical program to produce an output that identifies and highlights the net benefits, i.e., total benefits adjusted for total costs that are accumulated over a desired implementation including Demand Response benefits estimated in Step 2 while encoding the benefit realization delays from Step 1. In more detail Step (3) does so by developing a smart meter deployment plan that achieves the above objectives in view of hard budget constraints in model time periods, meter availability constraints with procurement lead-time, lower bounds on desired net benefits in each model time period, workforce acquisition/training costs, actual lead-times, and other constraints.

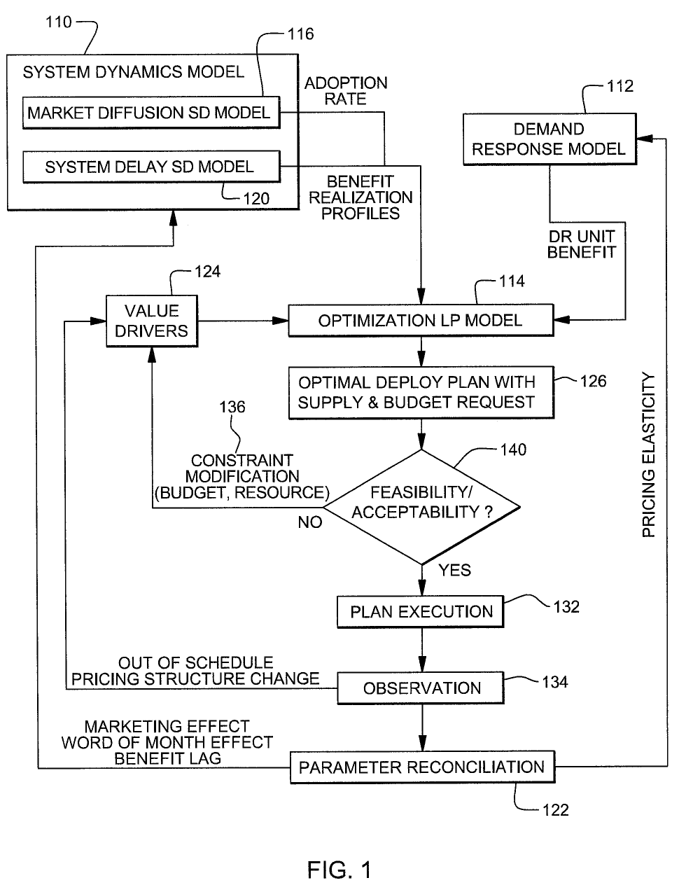

FIG. 1 shows the information flow among various modeling components of an embodiment of the inventive system and method. FIG. 1 represents the System Dynamics Model at 110, the Demand Response Model at 112 and the Optimization Model at 114. The System Dynamics Model, in turn, includes the Market Diffusion SD Model 116 and the System Delay SD Model 120. The Market Diffusion SD Model 116 receives parameter inputs, or Parameterization, represented at 122, such as marketing effectiveness and customer contact rate. These parameter inputs or values are boot-strapped in a first phase of program flow, and are obtained (derived) from historical data in other technology adoption processes. As an example, these parameters may include data from market penetration of natural gas vehicles, observed values from pilot programs deploying AMI in the electricity industry, etc., and are calibrated from partially available actual data in the second phase. This model 116 will generate customer adoption rate, as well as the time lag between deployment and benefits realization, as inputs into the optimization model.

Demand Response Model 112 uses hourly load and dynamic pricing information, as well as pricing elasticity to assess benefit (cost saving), and to generate unit benefit (per meter) as a function of penetration rate as an output, which is input to the Optimization Model on Program Management 114. The pricing elasticity, which measures demand change with respect to the price change, is estimated based on a commonly accepted value (−0.3) in the first iteration, and is subsequently updated using parameter reconciliation 122, when there is observable data available in the deployment process. The Optimization Model on Program Management 114 receives the calculated output from the Market Diffusion SD Model 116 and Demand Response Model 112 and Value Drivers 124, like labor unit cost, material unit cost, etc. and schedule factors, like start date, labor duration. The Optimization Model on Program Management 114 generates and outputs a meter deployment plan, represented at 126, that satisfies the specified budget, material supply and workforce constraints. The plan could be modified if it is not acceptable, or infeasible, at 140 by examining projected cost and benefit outlook and revising the constraints imposed in 136, upon the optimization model in 114. When changes in real-time data occur, like energy or deployment cost changes, supply shortages, workforce unavailability, etc., during the deployment plan execution, represented at 132, the Optimization Model on Program Management 114 can be rerun for the remaining period with new information, e.g., Observations, represented at 134, to dynamically re-plan the deployment process. The observation gives us time-varying records about customer adoption rate, and actual demand influence from pricing, which will be used to calibrate the parameters, marketing effectiveness and world mouth effectiveness in SD models, and price elasticity in the demand response model to create a recalibrated penetration profile. The systems dynamics models in 110, the demand response model in 112, and the optimization model in 114 are re-run with the revised estimates of the parameters (marketing effectiveness and world mouth effectiveness in Systems Dynamics models, and price elasticity in the demand response model) in order to arrive at a revised deployment plan.

Moreover, because many utility companies manage multiple jurisdictions, or grids, and of course must operate with budgets, supply and workforce constraints, represented at 136, any business plan should deploy smart meters in a certain order among the various jurisdictions and associated grids. For example, different jurisdictions may employ different scenarios in which deployed labor cost differs due to the difference of residential density, etc. Embodiments of the invention address this issue by allowing a user to specify different cost structure and schedule requirements. As represented at 140, the optimization model takes all these factors into its formulation and generates an optimal plan that balances the cost and benefit among multiple jurisdictions.

As mentioned above, the Market Diffusion System Dynamics Model to model may be used to model market diffusion. This model provides a capability to visually describe casual relationship among factors (tangible and intangible), and to quantify the relationship in a rational manner (dynamic hypotheses—physical law to drive the system evolution). The model is calibrated through parameter estimation techniques based on observable data. The Market Diffusion System Dynamics Model is used to predict customer adoption percentage periodically among all customers that have smart meters installed. There are two driving forces that change adoption rate. One is through marketing effort. Since smart meters and their potential benefit to utility customers is so new, after installing smart meters, customers might not be aware of their benefit, and require time to become familiar with the system. The other driving force would be “word of month” effect through customer contact.

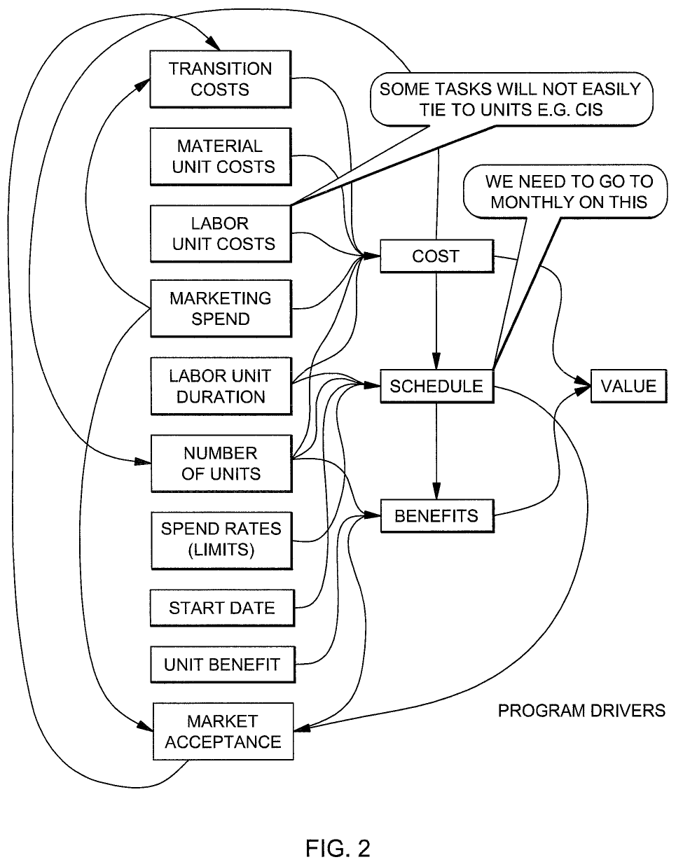

FIG. 2 shows more specifically some of the factors that may be taken into consideration to generate the meter deployment plan. For example, transition costs, material unit costs, labor unit duration, and marketing examples may all contribute to the cost of the project. Also, the labor unit duration, the number of units delivered, the spend rate per unit, and the start date of the project may be factors that are used to determine the schedule for the project. The number of units delivered, the unit benefits and market acceptance may be factors that are used to determine the benefits of the project. As illustrated in FIG. 2, the cost and benefits may then be used to determine the value of the project.

The present invention, as mentioned above, preferably uses the System Dynamics methodology to model market diffusion. System Dynamics gives a capability to visually describe casual relationship among factors (tangible and intangible) and to quantify the relationship in a rational manor (dynamic hypotheses physical law to drive the system evolution). The model can be calibrated through parameter estimation techniques based on observable data. The market diffusion has been studied and applied to analyze market penetration for other processes of new product and/or technology development, such as new energy technologies and for natural gas vehicles in Switzerland.

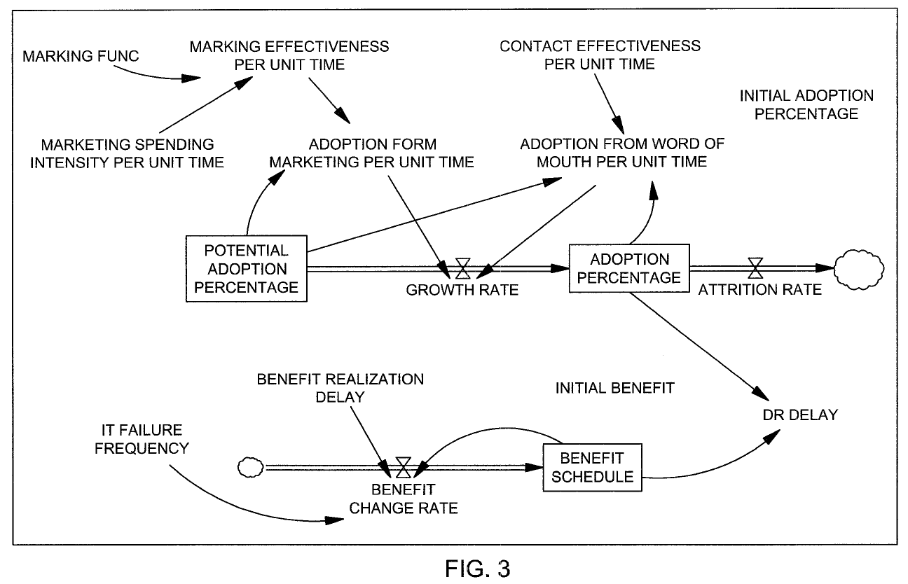

In its preferred implementation, this invention needs to predict customer adoption percentage from time to time among all customers that have smarter meters installed. There are two driving forces to change the adoption rate. One is through marketing effort. In fact, after installing smart meters, customers might not be aware of the benefit of that infrastructure and may need time to become familiar with the system. The other driving force would be “word of month” effect through customer contact. As an example, one suitable System Dynamics model is shown in FIG. 3 with both influence factors being included.

FIG. 3 shows that, for example, marketing effectives is determined, in part, by Marketing spending intensity. In turn, marketing effectiveness is one factor that determines adoption from marketing per unit time. Also, as illustrated in FIG. 3, the adoption percentage rate is determined by the potential adoption percentage, the growth rate and the attrition rate.

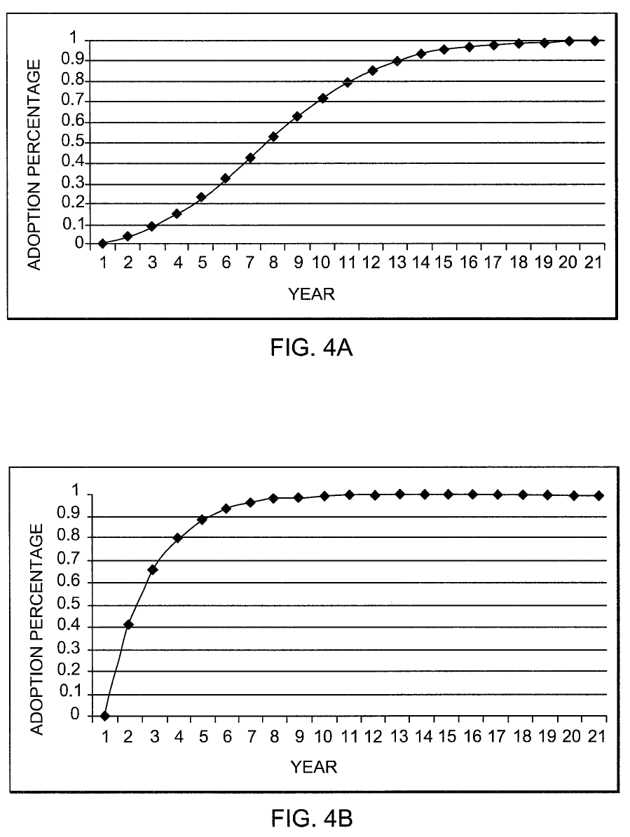

The Systems Dynamic Model may be written as a differential equation:

$$\frac{d A}{d t} = m \cdot ( 1 - A ) + c \cdot A \cdot ( 1 - A ) , \qquad ( 1 )$$

where A corresponds to adoption Percentage in FIG. 3, m is for marking effectiveness per unit time, and c is for contact effectiveness per unit time. The first term in RHS accounts for the effect from marketing and the second term in RHS accounts for the effect resulting from the contact of un-adopted customers with adopted customers. Solving the differential equation results in:

$$A ( t ; m , c , {A}_{0} ) = \frac{( {cA}_{0} + m ) \cdot {e}^{( c + m ) - t} - m ( 1 - {A}_{0} )}{( {cA}_{0} + m ) \cdot {e}^{( c + m ) - t} + c ( 1 - {A}_{0} )} ,$$

where A(t,m,c,A0) varies from the initial A₀ to 1. The adoption percentage and benefit realization are shown in FIGS. 4A and 4B, respectively. Note that, since A(t,m,c,A0) is for the adoption percentage, its value is always less than one. The initial phase of adoption, where A is close to zero, utility companies require capital investment on marketing and customer education to facilitate customer acceptance and utilization of the smart meters and AMI. The rate increase is mainly determined by the first term of the equation. As time elapses, the “word of month” influence would become the dominant force to convince people to adopt the new technology. At this time, the rate increase is mainly determined by the second term of Equation (1).

A is a multiplier of the number of customers with smart meters installed to figure out the number of adopted customers. The solution, for the dynamics of customer adoption, applies relative to the point in time when the smart meter is installed. Since the smart meters can be deployed in different times, the current total adopted customers is the summation of all adopted customers with different installation points in time. If M(s) is used to represent the number of meters installed at time s, then the total adopted customer until time t, MA(t), would be equal to

$$MA ( t ; m , c , {A}_{0} ) = {\sum }_{s = 0}^{t} M ( s ) \cdot A ( t - s ; m , c , {A}_{0} ) .$$

The effectiveness of marketing investment and word-of-month will vary, and these parameters are difficult to estimate accurately to begin with. The contact rate is different for each jurisdiction due to different population densities. Sometimes, word-of-month can have a negative effect, and some customer groups might not be sensitive to pricing signals and therefore not motivated to use the novel system. Also, the initial value for the adoption rate depends on marketing conditions or technology developing stages (emerging, mature and saturated). The impact from intangible variables related to soft factors, psychological influence is difficult to measure. In order to capture the correct adoption rate, a parameter calibration step is included in the solution framework. That is, in implementing AMI deployment, the number of the actual adopted customers is known until current time, and denoted as RA. Variables (m*,c*,A₀*) are derived using regression with the least squared error,

$$( {m}^{*} , {c}^{*} , {A}_{0}^{*} ) = argmin \{ {\sum }_{τ = 1}^{t} {[ MA ( τ ; m , c , {A}_{0} ) - RA ( τ ) ]}^{2} \} .$$

In the case when no real data is available, data from other new technology adoption process can be used to bootstrap the process.

Similarly, we use the first order delay to model benefit realization. The corresponding equation can be written as:

$$\frac{d B}{d t} = \frac{( ( 1 - α ) - B )}{{τ}_{D}} , \qquad ( 2 )$$

where B is for Benefit realization, α is the smart meter IT failure rate and τ_{D} is time delay parameter for delay in maturity of information systems. The equation (2) has the following solution:

B(t;α,τ_{D},B₀)=(1−α)−(1−α−B₀)·e^{-τ}^{_{D}}^{·1},

where B₀ is the initial value for B. The behavior of the solution is shown in FIG. 4B. The solution will asymptotically approach (1−α) for 0<B₀<1−α. The function is a multiplier and is applied relative to the deployment time of meter, similar to the adoption multiplier A. The (α,τ_{D},B₀) can be calibrated based on observable data in the same manner for A.

### Demand Response Model

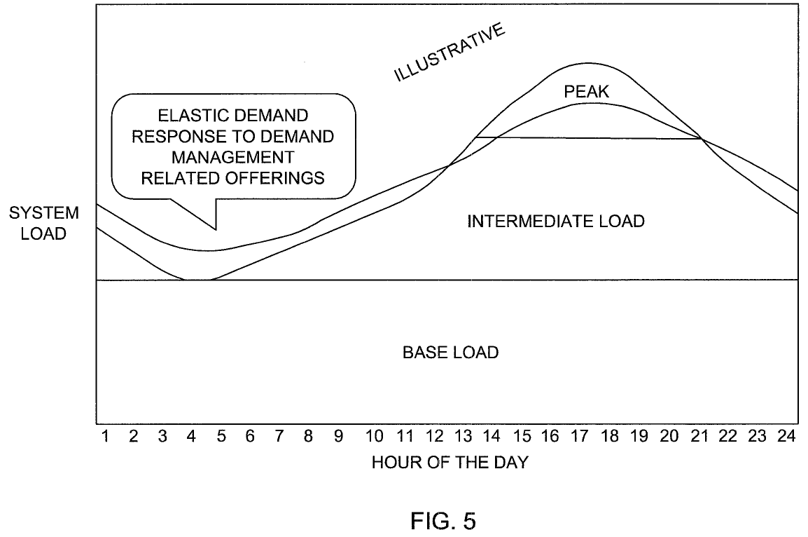

Assuming that a customer with an installed smart meter receives real time electricity prices and is price sensitive, the preferred system and method of the present invention estimates the cost saving associated with demand shifting from peak periods to off-peak periods, as illustrated in FIG. 5. In order to assess the cost savings related to demand shaping from market, the following quantities need to be estimated:

Market penetration (Mₚ), which is the percentage of customers that have smart meter installed that would take advantage of this feature and change their energy usage pattern. In fact, this is the same as the adoption percentage discussed above.

Price elasticity of demand (η), which is the percentage change in the demand for a 1% change in price. This is estimated using an empirically determined coefficient for price elasticity of demand. Typically, price sensitivity is negative (demand reduces with price increases). This is represented, in the disclosed embodiment, in a nominal value of −0.1 with a spread of [−0.15, −0.05].

The supply curve is approximated using the hourly price and load for each day. This data can be plotted as a curve from demand to clearing price (with price-demand pairs sorted in ascending order of price). For a given price, the load can be determined by interpolating over this curve. Demand shaving L, is determined by the following:

$${L}_{c} = η \cdot \frac{( p - {p}_{b} )}{{p}_{b}} \cdot ( L - {L}_{b} ) \cdot {M}_{p} ,$$

where L is the load, L_{b} is the base load, p is the price, p_{b} is the fixed price. The second factor on the RHS is the percentage change of price. The price pᵤ corresponding to the update load L+L_{c} is interpolated for the price within the supply curve that is approximated using hourly loads and clearing prices. Note that we smooth out the variability in the data locally (using a 3-4 hour time window). The saving is given by:

(L−Lₚ)·p−(L+L_{c}−Lₚ)·pᵤ.

That value is positive for p>p_{b} (increase price during peak hour) since L_{c}< and pᵤ<p . Note that the savings for even a low penetration (20%) of smart meters is substantial. However, many of the inputs, like fixed price and price elasticity, are based on estimates and, hence, need further calibration. This is preferably accommodated through some Monte Carlo based uncertainty analysis.

### Optimization Model

Mathematical programming techniques are used to address the time-tabling problem, to generate manufacturing plan and schedule to meet demand. The technique is used to create a smart meter deployment plan in the next 20 year span. The output from the models described above is used in the benefit estimates during the process of deploying smart meters. The invention, in the preferred embodiment, identifies a deployment plan that maximizes benefit and minimizes cost. The variable for deployment plan may be written as Y[j,t], where subscript j is for the jurisdiction index, and t is used for the time period. Formally, this objective can be expressed as:

$${max}_{Y} \{ \begin{matrix}{\sum }_{j = 1}^{N} {\sum }_{t = 1}^{T} ( Benefit - DeployCost - \\ OMCost - ExtraWF - h * ExtraM ) [ j , t ]\end{matrix} \} , \qquad ( O )$$

where h is the holding cost of extra meters in hand, N is the number of jurisdictions, and T is the time horizon. The expression sums over jurisdictions and over multiple time periods, and its solution addresses both the portfolio concern and budget distribution over the deployment span. The last two terms are used to penalize the extra meter supply and extra workforce. In fact, without them, the solution tends to allocate the enough resources at the first period.

The value of Y[j,t] varies from 0 to 1, and represents the percentage of meters that get installed, relative to the number of customers. Under the constraint of early start ES[j] and late finish LF[j], we have the following constraint, for each jurisdiction j:

$${\sum }_{t = 1}^{T} Y [ j , t ] = 1 ; Y [ j , t ] = 0 for t ∉ [ ES [ j ] , LF [ j ] ] . \qquad ( C1 )$$

### Benefit Formulation

Note that benefits are associated with the cumulative number of meters that have been installed, and depend on how long has any individual meter has been installed (to account for the lag in the benefit realization profile, as described above). This is further based on available estimates of the unit benefits BU and percentage growth BG related to various benefit categories (customer contact benefit, demand response benefit, meter reading benefit, asset optimization benefit etc.). For instance, a meter reading benefit is formulated as:

$$mrBenefit [ j , t ] = {BU}_{mr} [ j ] \cdot {( 1 + {BG}_{mr} [ j ] )}^{t - 1} \cdot M [ j ] \cdot {\sum }_{s = 1}^{t} \{ {B}_{j} ( t - s ) ( Y [ j , s ] + GR [ j ] \cdot {\sum }_{τ = 1}^{s} Y [ j , τ ] ) \} ,$$

where M[j] denotes the number of current customers who are considered to convert into smart meters. GR[j] is the customer growth rate in that jurisdiction j, and Bⱼ(t) is the benefit realization profile created from system dynamics model. The demand response benefit is slightly different from others, since it is also related to customer adoption rate A(t) that was estimated in system dynamics model. The unit of benefit is BU_{dr}, and is obtained from the demand response model described above.

$$drBenefit [ j , t ] = {BU}_{dr} [ j ] \cdot {( 1 + {BG}_{dr} [ j ] )}^{t - 1} \cdot M [ j ] \cdot {\sum }_{s = 1}^{t} \{ A ( t - s ) \cdot {B}_{j} ( t - s ) ( Y [ j , s ] + GR [ j ] \cdot {\sum }_{τ = 1}^{s} Y [ j , τ ] ) \} .$$

### Deployment and Operation Maintenance Cost

Deployment cost is associated with activities to install/or replace the meter, including both equipment cost and labor cost. There is a difference between the initial deployment cost and later replacement cost, since the latter only includes the incremental portion. Preferably, inflation associated with labor and equipment is included in the cost structure. For simplicity, the cost difference related to types of customers is ignored in the description of the formulation. Mathematically, the deploy cost is written as, for jurisdiction j at the time t:

$$DeployCost [ j , t ] = ⌊ {C}_{md} [ j ] \cdot {( 1 + {I}_{eq} )}^{t - 1} + {C}_{ld} [ j ] \cdot {( 1 + {I}_{la} )}^{t - 1} ⌋ \cdot M [ j ] \cdot Y [ j , t ] + [ {C}_{mr} [ j ] \cdot {( 1 + {I}_{eq} )}^{t - 1} + {C}_{lr} [ j ] \cdot {( 1 + {I}_{la} )}^{t - 1} ] \cdot M [ j ] \cdot ( GR [ j ] + NR [ j ] ) \cdot {\sum }_{s = 1}^{t} Y [ j , s ] .$$

The parameters used in the formulation are as follows:

C_{md}: The equipment cost for deployment, per meter

C_{ld}: The labor cost for deployment, per meter

Cₘᵣ: The equipment cost for replacement, per meter

Cₗᵣ: The labor cost for replacement, per meter

Cₒₘ: The communication cost during operation, per meter

Cₗₛ: The labor cost for service, per meter

Iₑₚ: The inflation rate for equipment, per year

Iₗₐ: The inflation rate for labor, per year

NR: The normal replacement rate, per year

It may be noted that the first term is for deployment cost, and the second term is for growth and normal replacement cost. Similarly, operation maintenance cost is given as:

$$OMCost [ j , t ] = ⌊ {C}_{om} [ j ] \cdot {( 1 + {I}_{eq} )}^{t - 1} + {C}_{ls} [ j ] \cdot {( 1 + {I}_{la} )}^{t - 1} ⌋ \cdot M [ j ] \cdot {\sum }_{s = 1}^{t} \{ Y [ j , s ] + GR [ j ] \cdot {\sum }_{τ = 1}^{s} Y [ j , τ ] \} .$$

It may be noted that the difference with deployment cost results from that of the maintenance cost is associated with the total number of meters being installed over time from 1 to t.

### Penalty Related to Resources

In an embodiment that includes additional variables for hiring, releasing workers and meter acquisition in the formulation, then we can address issues associated to supply delay and workforce shortage. It should be noted that both deployment and operation maintenance includes the labor cost that is formulated based on the unit cost per meter. If we assume average cost per worker C_{w}, then this cost can be translated into deploy and service workforce capacity requirements.

$$deployWC [ j , t ] = {C}_{ld} [ j ] \cdot {( 1 + {I}_{la} )}^{t - 1} \cdot M [ j ] \cdot Y [ j , t ] + {C}_{lr} [ j ] \cdot {( 1 + {I}_{la} )}^{t - 1} \cdot M [ j ] \cdot ( GR [ j ] + NR [ j ] ) \cdot {\sum }_{s = 1}^{t} Y [ j , s ] / {C}_{w}$$

$$serviceWC [ j , t ] = {C}_{ls} [ j ] \cdot {( 1 + {I}_{la} )}^{t - 1} \cdot M [ j ] \cdot {\sum }_{s = 1}^{t} \{ Y [ j , s ] + GR [ j ] \cdot {\sum }_{τ = 1}^{s} Y [ j , τ ] \} / {C}_{w} .$$

The available workforce capacity can be written as:

$$\begin{matrix}availableWC [ j , t ] = {W}_{i} [ j ] + {\sum }_{s = 1}^{t} ( {W}_{h} [ j , s - {LT}_{h} ] \cdot EL [ t - s - {LT}_{h} + 1 ] - {W}_{r} [ j , s ] ) & \\ {\sum }_{s = 1}^{t} ( {W}_{h} [ j , s - RT ] - {W}_{r} [ j , s ] ) \geq 0 & ( C2 ) \\ availableWC [ j , t ] \geq deployWC [ j , t ] + serviceWC [ j , t ] , & ( C3 )\end{matrix}$$

where Wᵢ is the number of initial workers, Wₕ[•,t] is the number of acquired workers at time t, and Wᵣ[•,t] is the number of released workers at time t. The parameter EL[t] is an experience level multiplier and changes from some value less then 1 to 1. Newly hired workers need time to learn and catch up, and then become fully experienced. The parameter RT in (C2) is minimal residence time for a new hired worker before which the worker may not be released. The constraint (C2) specifies the relationship between hiring and releasing workers. The constraint (C3) means that enough workers are needed to carry out the tasks. Note that deployWC and serviceWC are just intermediate variables.

Next, ExtraWF is formulated. This value is the extra cost associated with hiring and learning activity, sitting on bench (less utilized) due to worker release delay (minimal residence). It is given by:

$$ExtraWF [ j , t ] = {C}_{w} \cdot {( 1 + {I}_{w} )}^{t - 1} \{ \begin{matrix}{LT}_{h} \cdot {W}_{h} [ j , t ] + {\sum }_{s = 1}^{t} ( {W}_{h} [ j , s - {LT}_{h} ] - {W}_{r} [ j , s ] ) - \\ deployWC [ j , t ] - sevicesWC [ j , t ]\end{matrix} \} .$$

Without the term in the objective function, we could get a solution to hire enough workers in the first period and to release nobody in the later periods.

MP[•,t] is defined as procuring meters at time t. The ExtraM is equal to the accumulated number of procured meters minus the accumulated number of required meters:

$$\begin{matrix}ExtraM [ j , t ] = MI [ j ] + {\sum }_{s = 1}^{t} MP [ j , t - {LT}_{m} ] - M [ j ] \cdot {\sum }_{s = 1}^{t} \{ Y [ j , s ] + ( GR [ j ] + NR [ j ] ) \cdot {\sum }_{τ = 1}^{s} Y [ j , τ ] \} . \\ & \\ ExtraM [ j , t ] \geq 0 , & ( C4 )\end{matrix}$$

where MI are initial available meters and LTₘ is procuring lead time. So the first two terms represent available cumulative number of meters at time t. The third term, the accumulated number of required meters, includes deployment, growth and normal replacement portions. Without the term (ExtraM) in the objective function, we could get a solution to procure all meters in the first period.

### Constraints Being Considered

There are several resource constraints that can be imposed for solving the optimization problem, like budget upper bound, available workforce upper bound, procuring meter upper bound as well as benefit lower bound (least benefit expectation). Mathematically, at time t,

$$\begin{matrix} {\sum }_{j = 1}^{N} ( \begin{matrix}DeployCost [ j , t ] + OMCost [ j , t ] + \\ ExtraWF [ j , t ]\end{matrix} ) \leq investUB [ t ] , \\ & ( C5 ) \\ {\sum }_{j = 1}^{N} {W}_{h} [ j , t ] \leq hireUB [ t ] , & ( C6 ) \\ {\sum }_{j = 1}^{N} MP [ j , t ] \leq procureUB [ t ] , & ( C7 ) \\ {\sum }_{j = 1}^{N} Benefit [ j , t ] \geq benefitLB [ t ] . & ( C8 )\end{matrix}$$

By imposing some combination of constraints (C5) to (C8), the preferred embodiment of the invention addresses different concerns or issues during the deploy process. Some cases are discussed below.

### Simulation Scenarios and Results

In the case of excluding ExtraWF and ExtraM in the objective function, the invention provides a solution from minimizing the objective without any constraints. The preferred solution is to hire all needed workforce in the first period and to procure all needed meters in the first period since it does not involve any cost in the objective function, and to deploy all meters in the earliest start period, since this would achieve the maximum benefit. By including ExtraWF and ExtraM in the objective function, even without any constraints, the answer would be different: a) hiring would spread among the whole evaluation horizon with periodic releases (aligned with the optimal deployment plan) due to hiring cost and on-bench wasted cost, b) procurement of meters would be based on a requirement that aligns with the deployment plan, c) the deployment plan would potentially spread across multiple periods between the specified earliest start and the latest finish periods. From the optimized solution, the benefit, cost, workforce hiring, and meter procurement profile can be obtained along considered timeline.

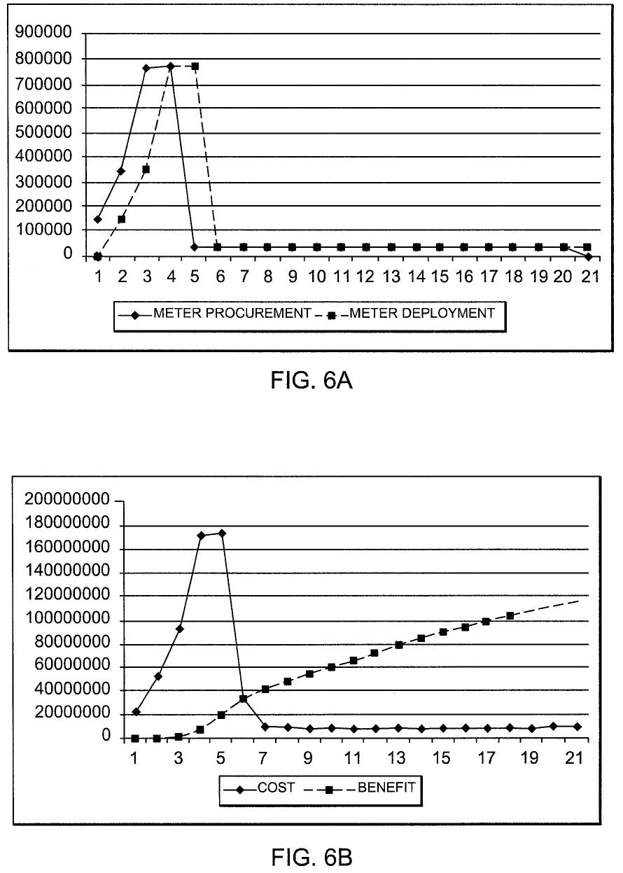

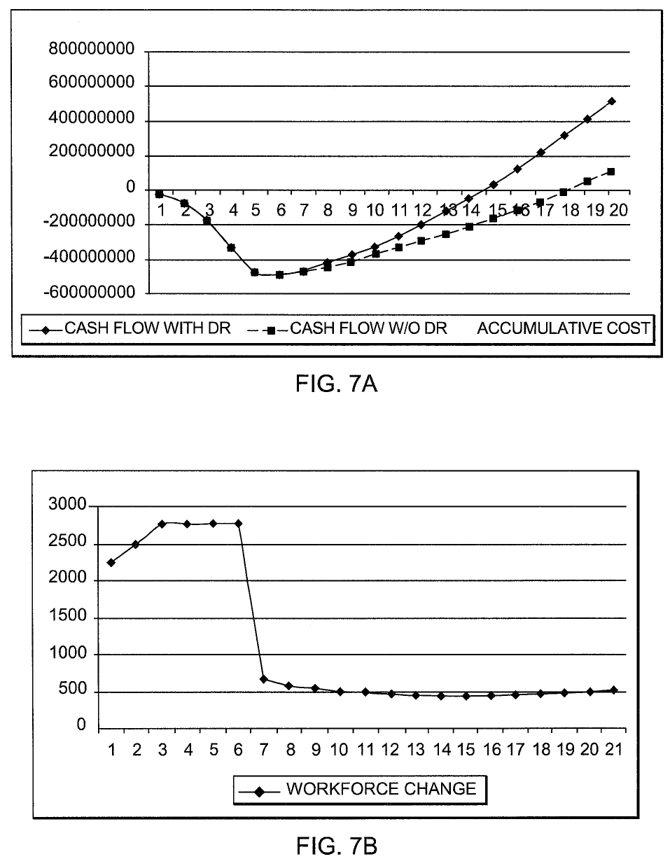

FIGS. 6A and 6B show the cost and benefit as well as the corresponding meter procurement for a time horizon of 21 years. Cost has a peak during deployment years (from 2 to 6) and benefit will pick up gradually after meters are installed. The meter procurement (the right graph in FIG. 6B) has the same figure as the meter deployment except it shifts to the left by one period due to procuring lead-time. FIGS. 7A and 7B together show the corresponding workforce profile. The span of the peak is much wider due to hiring and training lead-time (time taken to become fully experienced), and the minimum residence time constraint (workers can not be released immediately after hiring). The shape of the graph can be different in the outsourcing case, in which an outsourced worker can be released right away after finishing deployment. FIG. 7B shows cash flows for two cases: one with demand response benefit and the other one without it. The investment for deploying smart meters will pay off around year 14. The utility company will achieve profit based on that schedule.

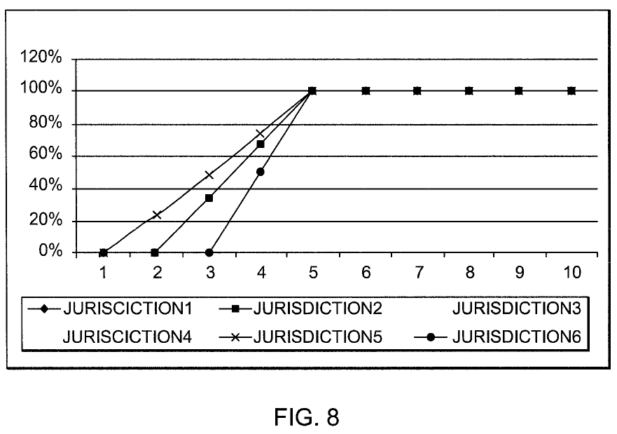

FIG. 8 shows the accumulative percentage deployment plan in different jurisdictions. For specified earliest start and latest finish periods, the optimizer would create the deployment plan in term of percentage of total current customers in that jurisdiction. Note that the solution gives an even distribution among the specified deployment periods under no budget constraints. The solution would be different for a mixed integer programming formulation, in which users are allowed to specify the early start, late start, duration and late finish, and there can be obtained a solution with different deploy cover periods.

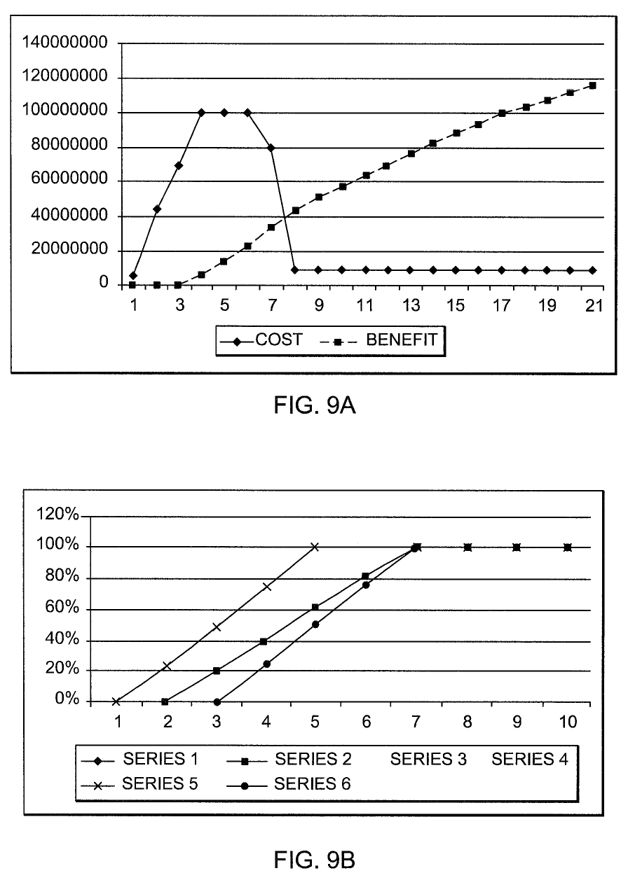

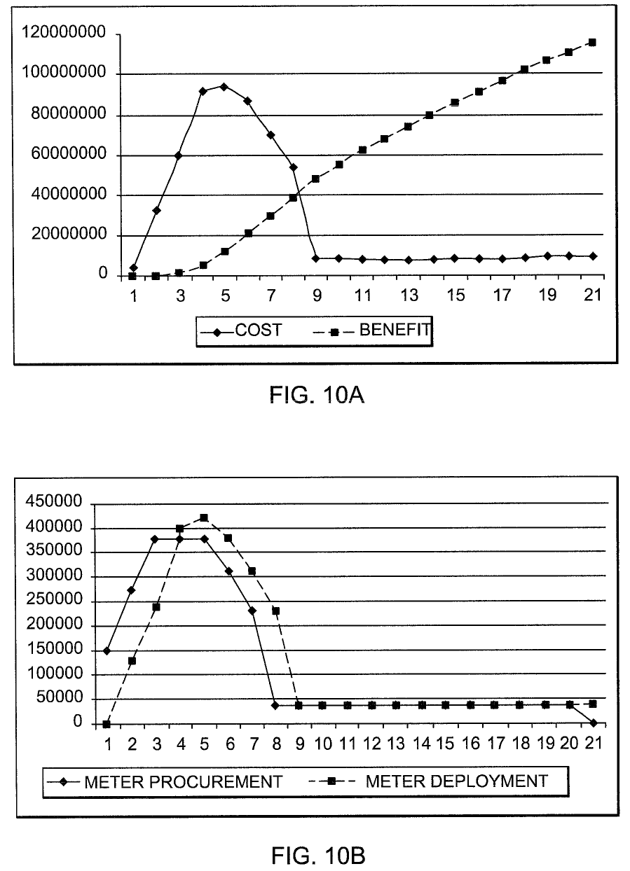

FIGS. 6A and 6B show that the cost at deployment peak could be very high. It is reasonable to impose annual budge and/or procurement constraints, and to relax late finish requirement. FIGS. 9A and 9B show the cost, benefit and deploy plan under a budget limit to be $100M during deploy period. FIGS. 10A and 10B show the cost, benefit and procurement profile under both budget limit to be 100M and meter procurement limit to be 380,000.

The model also allows the user to specify predefined deploy plan (specify percentage of meters deployed in each year for each jurisdiction). Then the optimizer would create cost, benefit, workforce and meter procurement profiles. The user can further add meaningful constraints based on the above-discussed outputs and re-create new deploy plan. In the case of deployment being the half way of process, the model can be used to re-plan based on observable data. The user can specify a deploy percentage that happened in the past and use the optimizer to create deploy plan for the rest of the periods.

The preferred embodiment of the invention, as described above in detail, provides an integrated model for AMI program management takes advantage of both system dynamics and linear programming methodologies. System dynamics is used to estimate intangible measures in the AMI deploying program management, like market penetration and benefit delay and employee experience profile. The linear programming is used to create deploying plan, meter procurement and workforce requirement. The model can address operation issue related to budget constraint, workforce and supply shortage. The feedback loop is built into the system in a general sense that the parameters in system dynamics can be calibrated from observable data as the program progresses.

The invention will be generally implemented by a computer executing a sequence of program instructions for carrying out the invention. The sequence of program instructions may be embodied in a computer program product comprising media storing the program instructions.

As will be readily apparent to those skilled in the art, the present invention, or aspects of the invention, can be realized in hardware, software, or a combination of hardware and software. Any kind of computer/server system(s)—or other apparatus adapted for carrying out the functions described herein—is suited. A typical combination of hardware and software could be a general-purpose computer system with a computer program that, when loaded and executed, carries out the functions, and variations on the functions as described herein. Alternatively, a specific use computer, containing specialized hardware for carrying out one or more of the functional tasks of the invention, could be utilized.

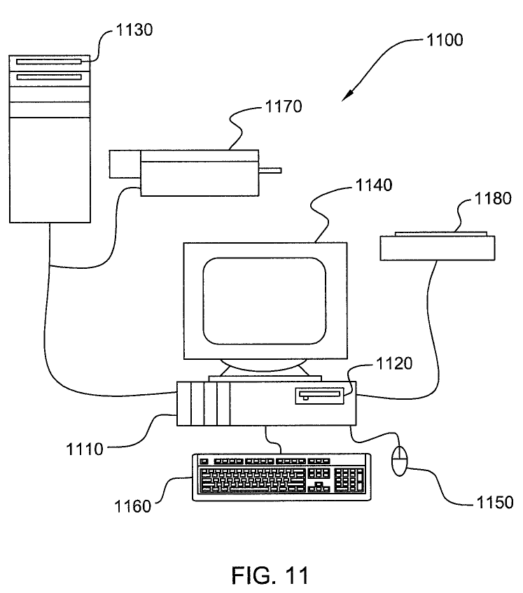

A computer-based system 1100 in which a method embodiment of the invention may be carried out is depicted in FIG. 11. The computer-based system 1100 includes a processing unit 1110, which houses a processor, memory and other systems components (not shown expressly in the drawing) that implement a general purpose processing system, or computer that may execute a computer program product. The computer program product may comprise media, for example a compact storage medium such as a compact disc, which may be read by the processing unit 1110 through a disc drive 1120, or by any means known to the skilled artisan for providing the computer program product to the general purpose processing system for execution thereby.

The computer program product may comprise all the respective features enabling the implementation of the inventive method described herein, and which—when loaded in a computer system—is able to carry out the method. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit 1110, as mentioned, or may be located on a remote system such as a server 1130, coupled to processing unit 1110, via a network interface such as an Ethernet interface. Monitor 1140, mouse 1150 and keyboard 1160 are coupled to the processing unit 1110, to provide user interaction. Scanner 1180 and printer 1170 are provided for document input and output. Printer 1170 is shown coupled to the processing unit 1110 via a network connection, but may be coupled directly to the processing unit. Scanner 1180 is shown coupled to the processing unit 1110 directly, but it should be understood that peripherals might be network coupled, or direct coupled without affecting the ability of the processing unit 1110 to perform the method of the invention.

Although examples of the present invention have been shown and described, it will be appreciated by those skilled in the art that changes might be made in these embodiments without departing from the principles and spirit of the invention, the scope of which is defined in the claims.

What is claimed is:

1. A method of modeling a plan for deployment of smart meters in a plurality of locations that are attached to a grid operated by an energy provider that supplies energy to said locations, wherein the smart meters are used to measure the energy supplied by the energy provider to said locations, the method comprising the steps of:
using a market diffusion model to create a time-varying user adoption profile, including estimating the time lagged benefits realized from deployment of the smart meters;
estimating a response in the demand for said energy due to adoption of the smart meters; and
using a program to capture the time-lagged benefits and a given set of constrains for a chosen planning time horizon to develop a meter deployment plan across the various locations and over the chosen planning horizon.

2. The method according to claim 1, comprising the further step of re-planning to account for changes of resource and budget, and to enable a parameter estimation functionality to iteratively calibrate the market diffusion model.

3. The method according to claim 1, wherein the step of using a market diffusion model includes the step of capturing the time-lagged benefit realization profiles for both demand response and non-demand response related benefits.

4. The method according to claim 3, wherein the step of capturing the time-lagged benefit realization profile includes the step of using a system dynamic model that includes technology diffusion related delays and system maturity related delays.

5. The method according to claim 4, wherein the system dynamic model addresses the user adoption percentage by estimating the adoption percentage dynamics using a logistic innovation diffusion model.

6. The method according to claim 4, wherein the system dynamic model addresses the demand response benefits realization due to:
1) system delay due to the time-maturity of information; and
2) adoption delay due to the dynamics of adoption percentage for Advanced Metering Infrastructure and Demand Response.

7. The method according to claim 1, wherein the estimating step includes the step of estimating the benefit from demand response using defined factors including time-of-use prices for the energy and fixed commodity price thresholds.

8. The method according to claim 7, wherein the defined factors further include load profiles and customer demand-price elasticity.

9. The method according to claim 1, wherein the step of using a program includes the step of setting up a program deployment model in the form of a mathematical program to develop the smart meter deployment plan subject to given budget constraints and given meter availability constraints.

10. The method according to claim 1, wherein:
the step of estimating the time lagged benefits realized from deployment of the smart meters includes estimating said time lagged benefits with consideration of plug-in hybrid automobiles and energy Sell-back enabled via an Advanced Metering Infrastructure (AMI), and without consideration of Plug-in-Hybrid automobiles and Energy Sell-back enabled via the AMI; and
the step of estimating a response in the demand for said energy due to adaption of the smart meters includes estimating said response in the demand for said energy with consideration of Plug-in-Hybrids and Energy Sell-back enabled via AMI, and without the consideration of Plug-in-Hybrid automobiles and Energy Sell-back enabled via the AMI.

11. A system for modeling a plan for deployment of smart meters in a plurality of locations that are attached to a grid operated by an energy provider that supplies energy to said locations, wherein the smart meters are used to measure the energy supplied by the energy provider to said locations, the system comprising one or more processor units configured for:
using a market diffusion model to create a time-varying user adoption profile, including estimating the time lagged benefits realized from deployment of the smart meters;
estimating a response in the demand for said energy due to adoption of the smart meters; and
using a program to capture the time-lagged benefits and a given set of constrains for a chosen planning time horizon to develop a meter deployment plan across the various locations and over the chosen planning horizon.

12. The system according to claim 11, wherein said one or more processor units are further configured for re-planning to account for changes of resource and budget, and to enable a parameter estimation functionality to iteratively calibrate the market diffusion model.

13. The system according to claim 11, wherein the one or more processor units are configured for using a market diffusion model by capturing the time-lagged benefit realization profiles for both demand response and non-demand response related benefits.

14. The system according to claim 13, wherein the one or more processor units are configured for capturing the time-lagged benefit realization profile by using a system dynamic model that includes technology diffusion related delays and system maturity related delays.

15. The system according to claim 11, wherein the one or more processor units are configured for estimating a response in demand by estimating the benefit from demand response using defined factors including time-of-use prices for the energy and fixed commodity price thresholds.

16. An article of manufacture comprising:
at least one computer usable medium having a computer readable program code logic to execute a machine instruction in a processing unit for modeling a plan for deployment of smart meters in a plurality of locations that are attached to a grid operated by an energy provider that supplies energy to said locations, wherein the smart meters are used to measure the energy supplied by the energy provider to said locations, said computer readable program code logic, when executing, performing the following steps:
using a market diffusion model to create a time-varying user adoption profile, including estimating the time lagged benefits realized from deployment of the smart meters;
estimating a response in the demand for said energy due to adoption of the smart meters; and
using a program to capture the time-lagged benefits and a given set of constrains for a chosen planning time horizon to develop a meter deployment plan across the various locations and over the chosen planning horizon.

17. The article of manufacture according to claim 16, wherein said steps further comprise the step of re-planning to account for changes of resource and budget, and to enable a parameter estimation functionality to iteratively calibrate the market diffusion model.

18. The article of manufacture according to claim 16, wherein the step of using a market diffusion model includes the step of capturing the time-lagged benefit realization profiles for both demand response and non-demand response related benefits.

19. The article of manufacture according to claim 18, wherein the step of capturing the time-lagged benefit realization profile includes the step of using a system dynamic model that includes technology diffusion related delays and system maturity related delays.

20. The article of manufacture according to claim 16, wherein the step of estimating a response in demand includes the step of estimating the benefit from demand response using defined factors including time-of-use prices for the energy and fixed commodity price thresholds.
